(19) United States
(12) Patent Application Publication
(10) Pub. No.: US 2015/0323855 A1
(43) Pub. Date: Nov. 12, 2015

(54) Quick release camera mounting system

(71) Applicant: Jeffrey Overall, Fountain Valley, CA (US)

(72) Inventor: Jeffrey Overall, Fountain Valley, CA (US)

(21) Appl. No.: 14/545,772

(22) Filed: Jun. 17, 2015

(51) Int. Cl. G03B 17/56

(52) U.S. Cl. CPC G03B 17/561; G03B 17/566

(57) ABSTRACT

The present invention is generally directed to a quick release camera mounting system, and related methods. It is more specifically directed to a quick release camera mounting system that allows for attachment of accessories, and related methods. In one aspect, the present invention provides a quick release camera mounting system. The system comprises a quick release plate and a quick-release receiver. The quick release plate comprises at least one tab having a through-hole which can be used to attach a camera to the quick release plate. The quick release plate is slidably inserted into a quick release receiver, and the quick release receiver comprises a quick release lever that allows the quick release plate to be removed from the quick release receiver. The quick release receiver further comprises means to connect to a camera accessory.

### FIELD OF THE INVENTION

The present invention is generally directed to a quick release camera mounting system, and related methods. It is more specifically directed to a quick release camera mounting system that allows for attachment of accessories, and related methods.

### BACKGROUND OF THE INVENTION

There has been research and development related to camera mounting systems. For instance, U.S. Pat. No. 8,827,574, entitled “Camera Mounting Assembly” is allegedly concerned with the following: “A camera mounting assembly includes a base member or plate for holding a camera and a side member or plate. In an exemplary embodiment, lower slots on the base plate or side slots on the side plate are gripped by a vertical support's quick-release mechanism to mount the camera in a landscape or portrait orientation, respectively, the camera being generally centered and evenly balanced over the support in either case. The side member is detachably fastened to the base member, which modular construction permits separately timed purchase of the base member and side member as allowed by the user's budget and further permits breakdown of the assembly for ease of transport. The side member may be generally L-shaped with a lower arm length less than the side arm length, which also facilitates transport. Other components may be detachably added such as a hand grip facilitating freehand shooting with the camera.” Abstract.

U.S. Pat. No. 8,727,642, entitled “Quick-Release Camera Mounting System” allegedly discusses the following: “There is provided a quick-release camera mounting system for connecting a camera to an object, such as tripod, backpack strap or belt. The camera has a base. The system includes an adapter with a base that is connectable to the object. The adapter has a protrusion that operatively connects to and extends outwards from its base. The system includes a camera mount threadably connecting to the base of the camera and for connecting with the adapter. The camera mount has a locking mechanism capable of quickly releasing the adapter from the camera mount. The locking mechanism includes a centrally disposed recessed portion. The protrusion of the adapter is shaped to fit within the recessed portion and engage with the locking mechanism for selectively connecting the adapter to the camera mount.” Abstract.

Despite reported research and development, there is still a need for new quick release camera mounting systems and related methods.

### BRIEF DESCRIPTION OF THE DRAWINGS

FIG. 1 shows a front view of one embodiment of a quick release camera mounting system according to the present invention.

FIG. 2 shows a side view of one embodiment of a quick release camera mounting system according to the present invention.

FIG. 3 shows a front view of one embodiment of a quick release camera mounting system according to the present invention, where a camera and an accessory are attached to the system.

FIG. 4 shows a front view of a second embodiment of a quick release camera mounting system according to the present invention.

FIG. 5 shows a bottom view of a second embodiment of a quick release camera mounting system according to the present invention.

FIG. 6 shows a front view of a third embodiment of a quick release camera mounting system according to the present invention.

FIG. 7 shows a bottom view of a third embodiment of a quick release camera mounting system according to the present invention.

### SUMMARY OF THE INVENTION

In one aspect, the present invention provides a quick release camera mounting system. The system comprises a quick release plate and a quick release receiver. The quick release plate comprises at least one tab having a through-hole which can be used to attach a camera to the quick release plate. The quick release plate is slidably inserted into a quick release receiver, and the quick release receiver comprises a quick release lever that allows the quick release plate to be removed from the quick release receiver. The quick release receiver further comprises means to connect to a camera accessory.

In another aspect, the present invention provides a method of quickly disconnecting a camera from an accessory. The method comprises actuating a quick release lever on a quick release plate to which the camera is attached, thereby releasing it from a quick release receiver to which the accessory is attached. The camera is attached to the quick release plate by at least one tab, and the accessory is attached to the quick release receiver by at least one mounting tab or at least one tripod female screw or an adhesive surface. The quick release plate is slidably inserted into the quick release receiver.

### DETAILED DESCRIPTION OF THE INVENTION

Definitions

“Accessory” refers to a device that can augment or complement camera performance or user experience. Nonlimiting examples of accessories include: screens, lights, remote controls, LCD screens, battery modules and smart phones.

“Adhesive surface” refers to a surface that is coated, partially or completely, with a substance used for sticking objects or materials together. The adhesive is typically industrial strength and water resistant (e.g., 3M adhesive).

“Camera” refers to a device for recording visual images in the form of photographs, film or video signals. Preferably, a camera used in the quick-release camera mounting system of the present invention is a sports action camera.

The present invention is generally directed to a quick release camera mounting system, and related methods. It is more specifically directed to a quick release camera mounting system that allows for attachment of accessories, and related methods. The present invention is discussed below in reference to the figures.

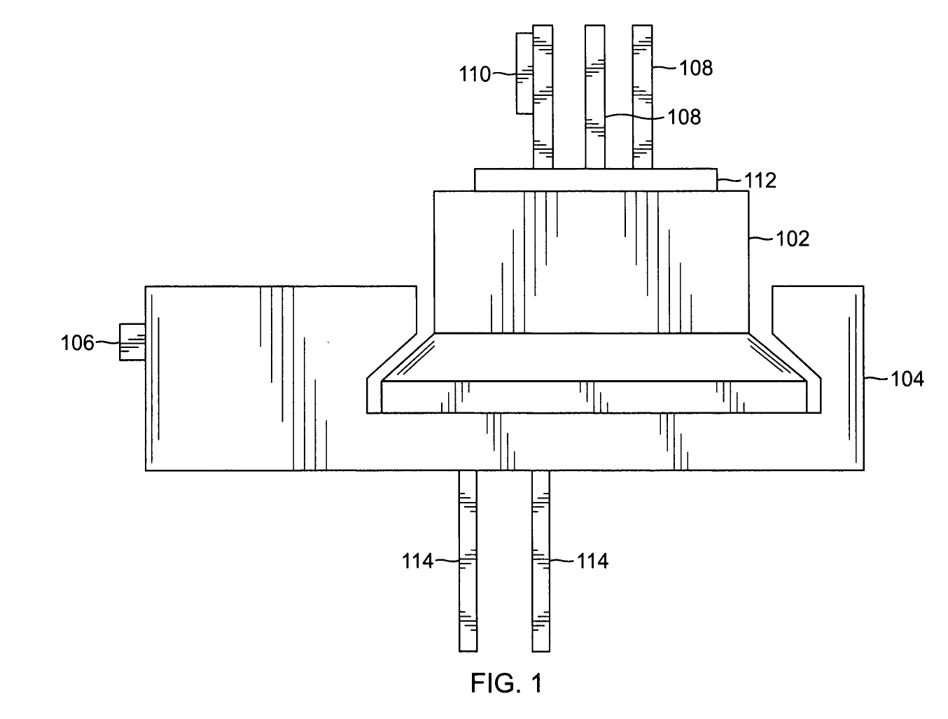

FIG. 1 shows a front view of one embodiment of a quick release camera mounting system 100 according to the present invention. Mount tabs 108 and retainer tab 110, which are used to connect a camera 122 (not shown) to the system, are attached to mount tab base 112. Mount tab base 112 is connected to quick release plate 102, which is shown inserted into quick release receiver 104. Quick release plate 102 is slidably inserted into quick release receiver 104 and is held in place by means of latch 138 (not shown). Quick release lever 106 operates the latch, allowing quick release plate 102 to be removed from quick release receiver 104. Accessory mount tabs 114 are attached to quick release receiver 104 and are used to connect a camera accessory 128 (not shown) to the quick release receiver 104.

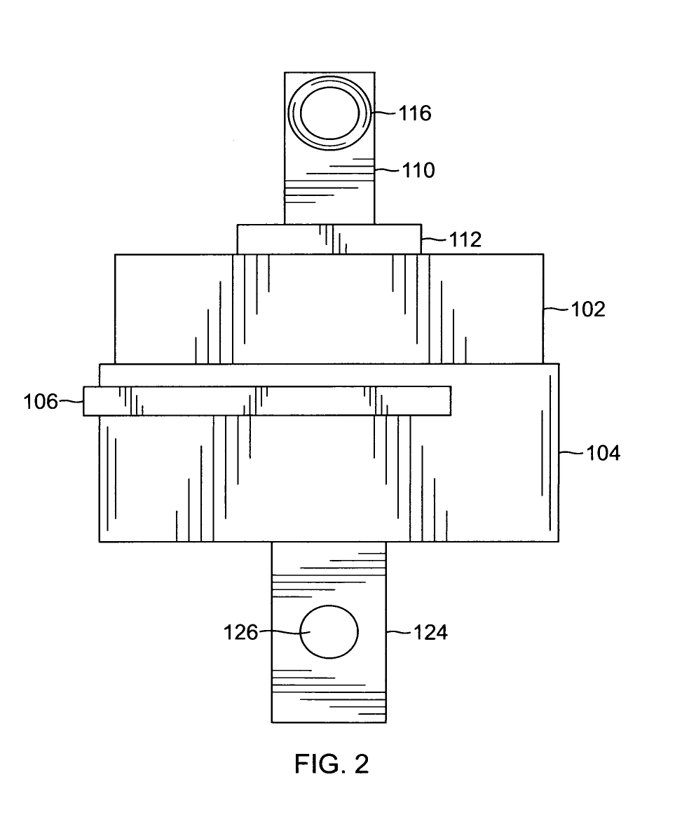

FIG. 2 shows a side view of one embodiment of a quick release camera mounting system according to the present invention. Retainer tab 110 includes a through hole for camera 116, which permits a camera 122 (not shown) to be secured to quick release plate 102. Retainer tab 110 is connected to quick release plate 102 by means of a mount tab base 112. Quick release plate 102 is slidably inserted into quick release receiver 104 and is held in place by latch 138 (not shown). Quick release lever 106 operates latch 138. Accessory mount tab 124, which includes a through hole for accessory 126, is attached to quick release receiver 104. The accessory mount tab 124 is used to connect a camera accessory 128 (not shown) to the quick release receiver 104.

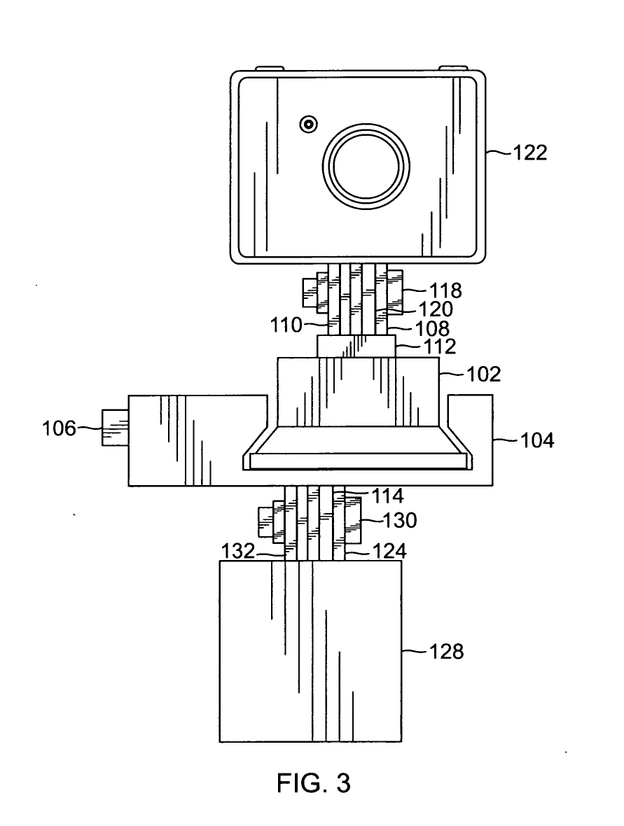

FIG. 3 shows a front view of one embodiment of a quick release camera mounting system according to the present invention, where a camera and an accessory are attached to the system. Camera 122 is connected to quick release plate 102 by insertion of through hole pin 118 into through holes (not shown) in mount tabs 108, camera tabs 120 and retainer tab 110. Mount tabs 108 and retainer tab 110 are attached to quick-release plate 102 by mount tab base 112, while camera tabs 120 (as shown) are connected to camera 122. Quick release plate 102 is slidably inserted into quick release receiver 104 and is held in place by latch 138 (not shown), which is operated by quick release lever 106. Accessory 128 is attached to quick release receiver 104 by insertion of accessory pin 130 into through holes (not shown) in accessory mount tabs 114, accessory tabs 124 and accessory retainer tab 132. Accessory mount tabs 114 are connected to quick release receiver 104, while accessory tabs 124 and accessory retainer tab are connected, directly or indirectly, to accessory 128.

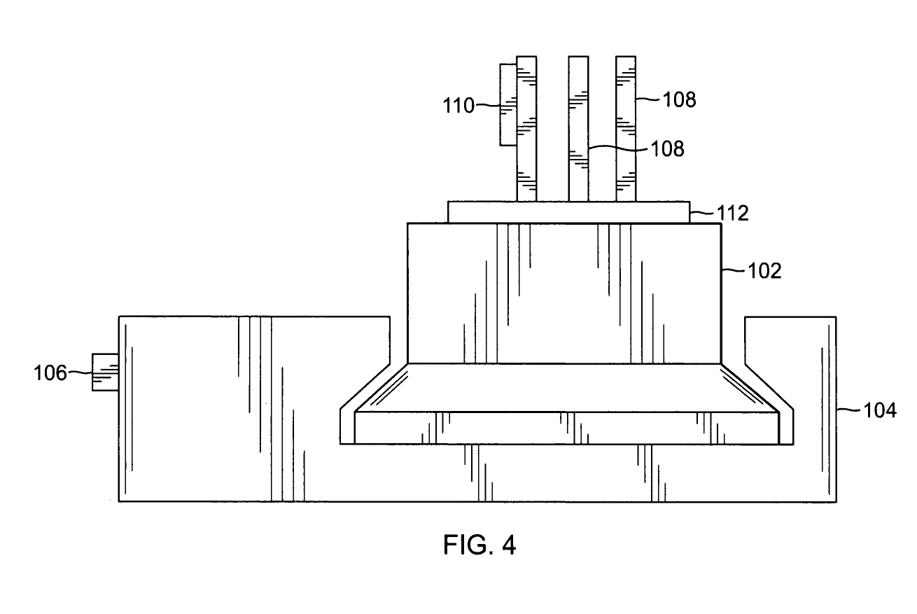

FIG. 4 shows a front view of a second embodiment of a quick release camera mounting system according to the present invention. Mount tabs 108 and retainer tab 110, which are used to connect a camera 122 (not shown) to the system, are attached to mount tab base 112. Mount tab base 112 is connected to quick release plate 102, which is shown inserted into quick release receiver 104. Quick release plate 102 is slidably inserted into quick release receiver 104 and is held in place by means of latch 138 (not shown). Quick release lever 106 operates the latch, allowing quick release plate 102 to be removed from quick release receiver 104.

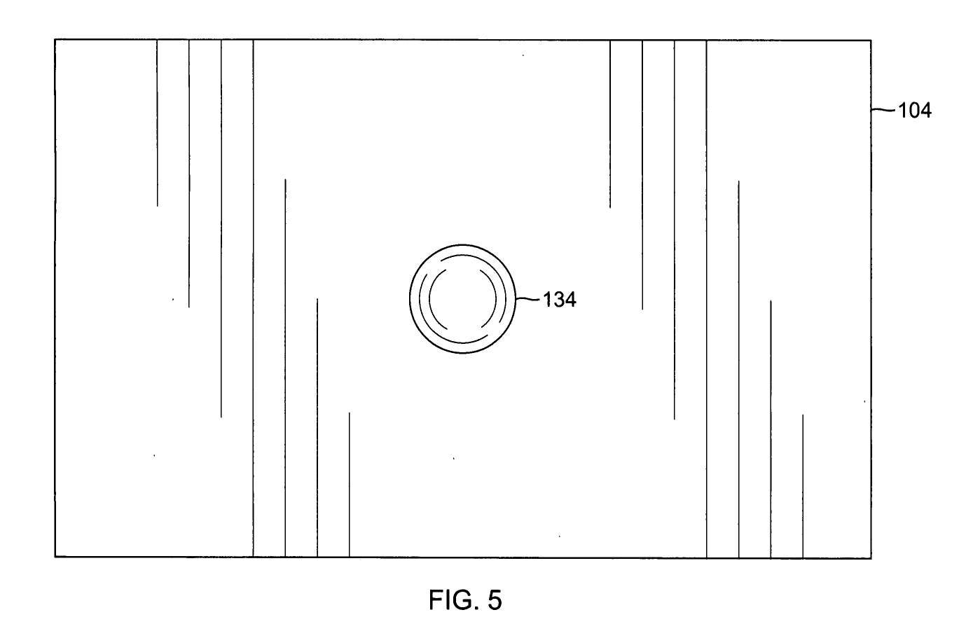

FIG. 5 shows a bottom view of a second embodiment of a quick release camera mounting system according to the present invention. Tripod female screw 134 is included in the bottom of quick release receiver 104. Tripod female screw 134 allows the attachment of accessories possessing a tripod screw.

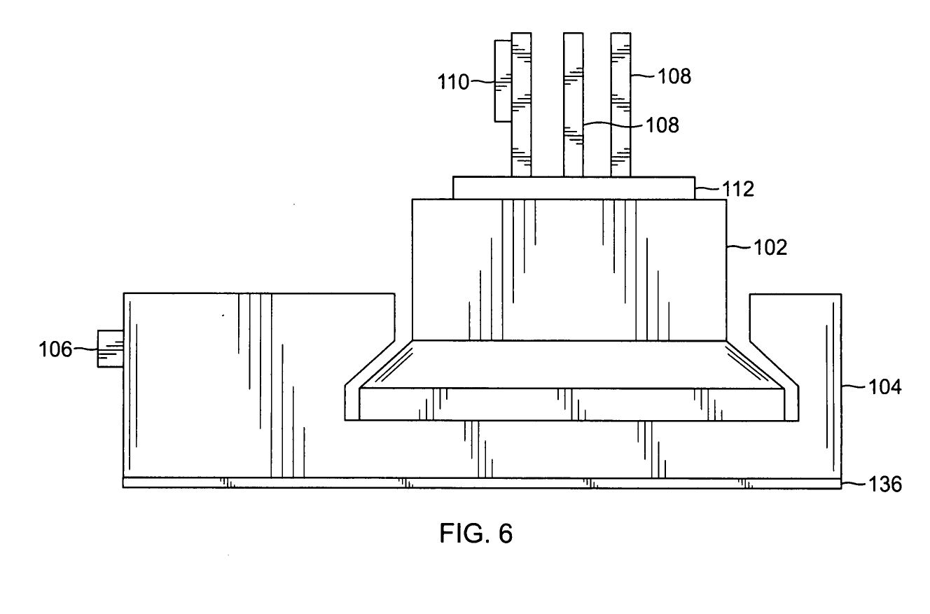

FIG. 6 shows a front view of a third embodiment of a quick release camera mounting system according to the present invention. Mount tabs 108 and retainer tab 110, which are used to connect a camera 122 (not shown) to the system, are attached to mount tab base 112. Mount tab base 112 is connected to quick release plate 102, which is shown inserted into quick release receiver 104. Quick release plate 102 is slidably inserted into quick release receiver 104 and is held in place by means of latch 138 (not shown). Quick release lever 106 operates the latch, allowing quick release plate 102 to be removed from quick release receiver 104. Adhesive surface 136 is attached to the bottom of quick release receiver 104. Adhesive surface 136 allows the connection of quick release mounting system 100 to other surfaces to which it can adhere (i.e., stick).

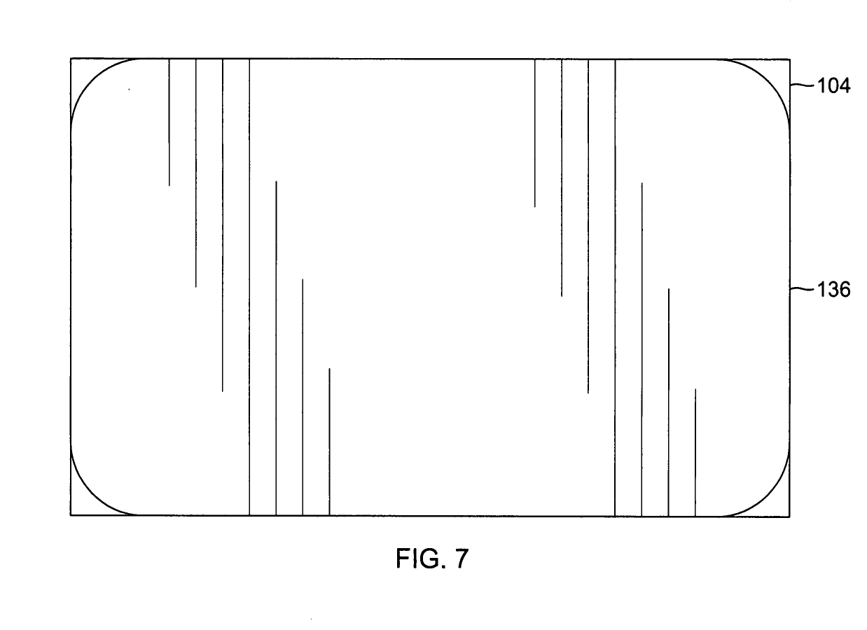

FIG. 7 shows a bottom view of a third embodiment of a quick release camera mounting system according to the present invention. Adhesive surface 136 is attached to the bottom of quick-release receiver 104.

The quick release camera mounting system of the present invention permits a camera user, typically a sports action camera user, to quickly (i.e., matter of seconds) disconnect a camera from an accessory. Conversely, it allows the user to quickly connect a camera to an accessory.

The foregoing accordingly gives rise to at least the following methods:

A method of quickly disconnecting a camera from an accessory, where the method comprises actuating a quick release lever on a quick release plate to which the camera is attached, thereby releasing it from a quick release receiver to which the accessory is attached. The camera is attached to the quick release plate by means of mount tabs and a retainer tab that are included on the quick-release plate. The accessory is attached to the quick release receiver by one of the following means: accessory mount tabs; one or more tripod screws; an adhesive surface. The quick release plate slidably inserts into the quick release receiver, and it is released in a matter of seconds upon actuation of the quick release lever (e.g., less than 5 seconds, 4 seconds, 3 seconds, 2 seconds or 1 second).

A method of quickly connecting a camera to an accessory, where the method comprises sliding a quick release plate, to which the camera is attached, into a quick release receiver, to which the accessory is attached. The camera is attached to the quick release plate by means of mount tabs and a retainer tab that are included on the quick release plate. The accessory is attached to the quick release receiver by one of the following means: accessory mount tabs; one or more tripod screws; an adhesive surface. Upon insertion of the quick release plate into the quick release receiver, a latch included in the quick release receiver (and operated by the quick release lever) securely connects the quick release plate to the quick release receiver.

Elements of Figures

Quick Release Camera Mounting System—100

Quick Release Plate—102

Quick Release Receiver—104

Quick Release Lever —106

Mount Tab—108

Retainer Tab—110

Mount Tab Base—112

Accessory Mount Tab—114

Through Hole for Camera—116

Through Hole Pin—118

Camera Tab—120

Camera—122

Accessory Tab—124

Through Hole for Accessory—126

Accessory—128

Accessory Pin—130

Accessory Retainer Tab—132

Tripod Female Screw—134

Adhesion Surface—136

1. A quick release camera mounting system, wherein the system comprises a quick release plate and a quick release receiver, and wherein the quick release plate comprises at least one tab having a through-hole which can be used to attach a camera to the quick release plate, and wherein the quick release plate is slidably inserted into a quick release receiver, and wherein the quick release receiver comprises a quick release lever that allows the quick release plate to be removed from the quick release receiver, and wherein the quick release receiver further comprises means to connect to a camera accessory.

2. The quick release camera mounting system according to claim 1, wherein the quick release plate comprises two mounting tabs and one retainer tab, all of which have a through-hole.

3. The quick release camera mounting system according to claim 1, wherein the quick release receiver comprises at least one mounting tab with a through-hole that allows connection of a camera accessory to the system.

4. The quick release camera mounting system according to claim 1, wherein the quick release receiver comprises a tripod female screw that allows connection of a camera accessory to the system.

5. The quick release camera mounting system according to claim 1, wherein the quick release receiver comprises an adhesive surface that allows connection of a camera accessory to the system.

6. A method of quickly disconnecting a camera from an accessory, wherein the method comprises actuating a quick release lever on a quick release plate to which the camera is attached, thereby releasing it from a quick release receiver to which the accessory is attached, and wherein the camera is attached to the quick release plate by at least one tab, and wherein the accessory is attached to the quick release receiver by at least one mounting tab or at least one tripod female screw or an adhesive surface, and wherein the quick release plate is slidably inserted into the quick release receiver.

7. The method according to claim 6, wherein the accessory is attached to the quick release receiver by two mounting tabs.

8. The method according to claim 6, wherein the accessory is attached to the quick release receiver using one tripod female screw.

9. The method according to claim 6, wherein the accessory is attached to the quick release receiver using an adhesive surface.

10. The method according to claim 6, wherein the quick release plate is disconnected from the quick release receiver in less than 2 seconds after actuation of the quick release lever.
